(19) United States
(12) Patent Application Publication
(10) Pub. No.: US 2026/0138588 A1
(43) Pub. Date: May 21, 2026

(54) PREEMPTIVE HIGH POWER ENGINE START SYSTEM

(71) Applicant: FCA US LLC, Auburn Hills, MI (US)

(72) Inventor: David N Flessner, Auburn Hills, MI (US)

(21) Appl. No.: 18/954,632

(22) Filed: Nov. 21, 2024

(51) Int. Cl. B60W 20/16; B60W 10/06; B60W 20/40

(52) U.S. Cl. CPC B60W 20/16; B60W 10/06; B60W 20/40; B60W 2510/068; B60W 2510/244; B60W 2556/10; B60W 2556/50; B60W 2710/0677; B60W 2710/0694; B60W 2710/086; B60W 2720/103

(57) ABSTRACT

A preemptive high-power engine start control system for a hybrid electric vehicle (HEV) having an electrified powertrain including an electric motor and an internal combustion engine. A controller is configured to perform operations including predict a vehicle travel route to a destination, determine one or more locations along the travel route where a high-power engine start will occur that requires propulsive power from both the electric motor and the internal combustion engine to satisfy a driver torque demand, and preemptively start the internal combustion engine prior to the vehicle reaching the one or more locations along the travel route where the high-power engine start will occur, to thereby facilitate preventing a torque delay during the high-power engine start.

### FIELD

The present application relates generally to electrified vehicles and, more particularly, to an electrified vehicle with a preemptive high power engine start system.

### BACKGROUND

Some electrified vehicles, such as hybrid electric vehicles (HEVs) and plug-in hybrid electric vehicles (PHEVs), are propulsively powered by an electrified powertrain that includes at least one electric motor and an internal combustion engine. Typically, the powertrain electrical system is capable of driving large steady-state speed range all electrically in an electric drive mode. However, for full acceleration capability, both the engine and the electric motor(s) are required. Accordingly, in cases where the driver requests more torque than the electrical system can provide in the electric drive mode, the engine is required to start to deliver the full torque request. However, this can result in a delay between the driver torque request and the powertrain delivering the torque, commonly referred to as a torque hole. Accordingly, while such conventional electrified powertrain systems work well for their intended purpose, there exists an opportunity for improvement in the relevant art.

### SUMMARY

In accordance with one example aspect of the invention, a preemptive high-power engine start control system for a hybrid electric vehicle (HEV) having an electrified powertrain including an electric motor and an internal combustion engine is provided. In one exemplary implementation, the preemptive high-power engine start control system includes a controller having one or more processors and a non-transitory computer-readable storage medium having a plurality of instructions stored thereon, which, when executed by the one or more processors, cause the one or more processors to perform operations. The operations include predict a vehicle travel route to a destination, determine one or more locations along the travel route where a high-power engine start will occur that requires propulsive power from both the electric motor and the internal combustion engine to satisfy a driver torque demand, and preemptively start the internal combustion engine prior to the vehicle reaching the one or more locations along the travel route where the high-power engine start will occur, to thereby facilitate preventing a torque delay during the high-power engine start.

In addition to the foregoing, the described preemptive high-power engine start control system may include one or more of the following features: wherein the controller is further configured to determine a vehicle speed profile and power demand along the travel route, and determine an expected engine and battery power split along the travel route; wherein the controller is further configured to determine the one or more locations along the travel route where the high-power engine start will occur, based on (i) the determined vehicle speed profile and power demand and (ii) the determined expected engine and battery power split; and wherein the controller is further configured to determine trigger criteria to initiate the preemptive high-power engine start, and preemptively start the internal combustion engine when the trigger criteria are met prior to the vehicle reaching the one or more locations along the travel route.

In addition to the foregoing, the described preemptive high-power engine start control system may include one or more of the following features: wherein the trigger criteria comprise a progress through the travel route and/or a battery state of charge condition; wherein the controller is further configured to determine a vehicle status of the HEV, send the vehicle status to a remote computing server, and receive, from the remote computing server, the determined one or more locations along the travel route where a high-power engine start will occur; and wherein the controller is further configured to receive, from the remote computing server, trigger criteria indicating when to initiate the preemptive high-power engine start, and preemptively start the internal combustion engine when the trigger criteria are met prior to the vehicle reaching the one or more locations along the travel route.

In addition to the foregoing, the described preemptive high-power engine start control system may include one or more of the following features: wherein the controller is further configured to determine a catalytic converter of the HEV is below a predetermined light-off temperature, and preemptively start the internal combustion engine prior to the vehicle reaching the one or more locations along the travel route where the high-power engine start will occur, to thereby warm the catalytic converter to the predetermined light-off temperature to reduce exhaust emissions; wherein the controller is further configured to predict the travel route based on user input into a GPS navigation system of the HEV; and wherein the controller is further configured to predict the travel route based on driving history data of the HEV.

In accordance with one example aspect of the invention, a preemptive high-power engine start control method for a hybrid electric vehicle (HEV) having an electrified powertrain including an electric motor and an internal combustion engine is provided. In one exemplary implementation, the method includes predicting, by a controller having one or more processors, a vehicle travel route to a destination; determining, by the controller, one or more locations along the travel route where a high-power engine start will occur that requires propulsive power from both the electric motor and the internal combustion engine to satisfy a driver torque demand; and preemptively starting the internal combustion engine, by the controller, prior to the vehicle reaching the one or more locations along the travel route where the high-power engine start will occur, to thereby facilitate preventing a torque delay during the high-power engine start.

In addition to the foregoing, the described method may include one or more of the following features: determining, by the controller, a vehicle speed profile and power demand along the travel route, and determining, by the controller, an expected engine and battery power split along the travel route; determining, by the controller, the one or more locations along the travel route where the high-power engine start will occur, based on (i) the determined vehicle speed profile and power demand and (ii) the determined expected engine and battery power split; and determining, by the controller, trigger criteria to initiate the preemptive high-power engine start, and preemptively starting the internal combustion engine, by the controller, when the trigger criteria are met prior to the vehicle reaching the one or more locations along the travel route.

In addition to the foregoing, the described method may include one or more of the following features: wherein the trigger criteria comprise a progress through the travel route and/or a battery state of charge condition; determining, by the controller, a vehicle status of the HEV, sending, by the controller, the vehicle status to a remote computing server, and receiving, from the remote computing server and by the controller, the determined one or more locations along the travel route where a high-power engine start will occur; and receiving, from the remote computing server, trigger criteria indicating when to initiate the preemptive high-power engine start, and preemptively starting the internal combustion engine, by the controller, when the trigger criteria are met prior to the vehicle reaching the one or more locations along the travel route.

In addition to the foregoing, the described method may include one or more of the following features: determining, by the controller, if a catalytic converter of the HEV is below a predetermined light-off temperature, and preemptively start the internal combustion engine, by the controller, prior to the vehicle reaching the one or more locations along the travel route where the high-power engine start will occur, to thereby warm the catalytic converter to the predetermined light-off temperature to reduce exhaust emissions; wherein the predicted travel route is based on user input into a GPS navigation system of the HEV; and wherein the predicted travel route is based on driving history data of the HEV.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example electrified vehicle having a preemptive high-power engine start system in accordance with the principles of the present application;

FIG. 2 is a flow diagram of an example preemptive high-power engine start control method, in accordance with the principles of the present application; and

FIG. 3 is a flow diagram of another example preemptive high-power engine start control method, in accordance with the principles of the present application.

### DETAILED DESCRIPTION

As previously discussed, some electrified vehicles like hybrid electric vehicles (HEVs) include an electrified powertrain having one or more electric traction motors and an internal combustion engine. The electrified powertrain is capable of transitioning between an all-electric drive mode and a hybrid drive mode (engine and e-motor). For full acceleration capability, both the engine and electric motor(s) are required. However, when a driver requests more torque than the electric system can provide in the electric drive mode, the engine is required to start (high-powered engine start). This may result in a torque delay while the engine is started. Moreover, if vehicle catalytic converter(s) are cold when the high-power engine start, tailpipe emissions may be much higher than lower engine power starts.

Accordingly, systems and methods are provided herein for a preemptive high-power engine start to reduce torque delay and tailpipe emissions. The system is configured to determine an expected vehicle route, for example via GPS navigation and/or artificial intelligence (AI) prediction, and combine the route with vehicle data provided to the cloud to predict the locations of the route when high-power engine starts would occur (e.g., highway on-ramps, turns from side street to major road, etc.). With the potential high-power engine start locations identified, the control system is configured to command an engine start before the expected high power starts.

In general, a cloud-based computing server and/or onboard controller includes one or more algorithms to predict if the driver is approaching a high-power start, and subsequently communicates trigger conditions to the vehicle to proactively start the engine before the driver power demand increases such that the engine is already coupled to the driveline and ready to provide torque when the driver requests it. Additionally, if the catalyst is cold, the extra time would allow the engine to heat the catalyst before the high-power demand.

The system advantageously enables HEV drivers to be more confident in the performance of the powertrain and smooth electric to engine-on transitions by removing the uncertain moments where the driver is waiting for engine power to be delivered. In this way, drivability is improved by starting the engine before it is needed, which couples the engine to the driveline and enables the vehicle to be ready to closely follow the requested torque from the driver with minimal delay. Further, the system is configured to reduce tailpipe emissions for high-power cold starts by heating the catalyst to a predetermined catalyst light-off temperature before the high-power demand. In one example, the predetermined light-off temperature is a temperature that enables the catalytic converter (catalyst) to efficiently remove/convert one or more exhaust gas constituents (e.g., CO, CO2, O2, HC, NMHC, NOx, etc.).

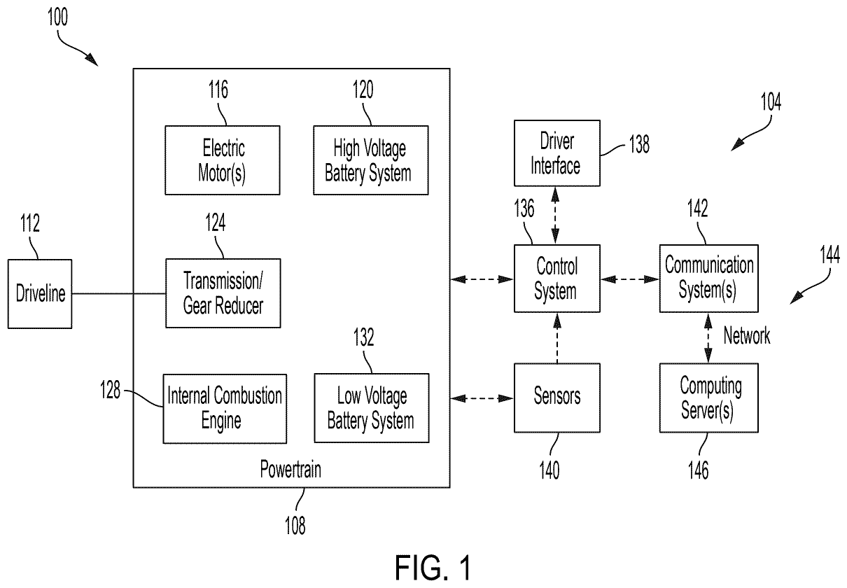

With initial reference to FIG. 1, a functional block diagram of an electrified vehicle 100 having an example preemptive high-power engine start system 104 according to the principles of the present application is illustrated. The electrified vehicle 100 could be any suitable type of electrified vehicle, including, but not limited to, a HEV. The electrified vehicle 100 comprises an electrified powertrain 108 configured to generate and transfer drive torque to a driveline 112 for vehicle propulsion. The electrified powertrain 108 includes one or more electric traction motors 116 each configured to generate mechanical drive torque using energy (e.g., electrical current) supplied by a high voltage (HV) battery system 120. For example, an inverter (not shown) could be used to convert the direct current (DC) from the high voltage battery system 120 to three-phase alternating current (AC) to power the electric traction motor(s) 116. A transmission 124 (e.g., an automatic transmission) is configured to transfer the drive torque from the electrified powertrain 108 to the driveline 112.

The electrified powertrain 108 also includes an internal combustion engine 128 configured to combust a mixture of air and fuel (gasoline, diesel, etc.) to generate mechanical torque for vehicle propulsion and/or conversion to electrical energy, such as for recharging battery system 120. A low voltage battery system 132 (e.g., a 12-volt (V) battery) is configured to power low voltage components and accessory loads of the electrified vehicle 100.

A control system 136 is configured to control the electrified powertrain 108, including controlling the electrified powertrain to generate an amount of drive torque to satisfy a torque request provided by a driver/operator via a driver interface 138 (e.g., an accelerator pedal). A plurality of sensors 140 are configured to measure operating parameters of the electrified vehicle 100, such as, but not limited to, speeds/accelerations, pressures, temperatures, and electrical parameters (voltage, current, state of charge, etc.). The sensors 140 also include other vehicle systems, such as a GPS navigation/maps system.

The control system 136 is also configured to communicate with other devices/systems using one or more communication systems 142 each configured for communication via a particular communication network or medium 144. For example, the communication systems 142 could include a long-range cellular communication transceiver, and/or a short-range wireless communication (e.g., Bluetooth) transceiver. The network 144 can be any suitable communication network including, for example, a satellite network, a cellular network (3G, 4G LTE, 5G, etc.), a computing network (local area network, the internet, etc.), or some combination thereof.

One particular communication by the control system 136 via the communication system(s) 142 is with a set of one or more computing servers 146 that store/analyze data provided by the vehicle 100. The computing servers 146 may be owned and operated by a particular vehicle original equipment manufacturer (OEM) or other entity and may only be accessible to authorized users, such as through a computer application. The computing servers 146 may be a cloud-based system having one or more algorithms having direct access to vehicle data (e.g., trip navigation). The cloud-based computing servers 146 can have substantial computing resources for execution of the algorithms. In some alternative implementations, the algorithms and/or operations described herein may be performed partially or solely by the control system 136.

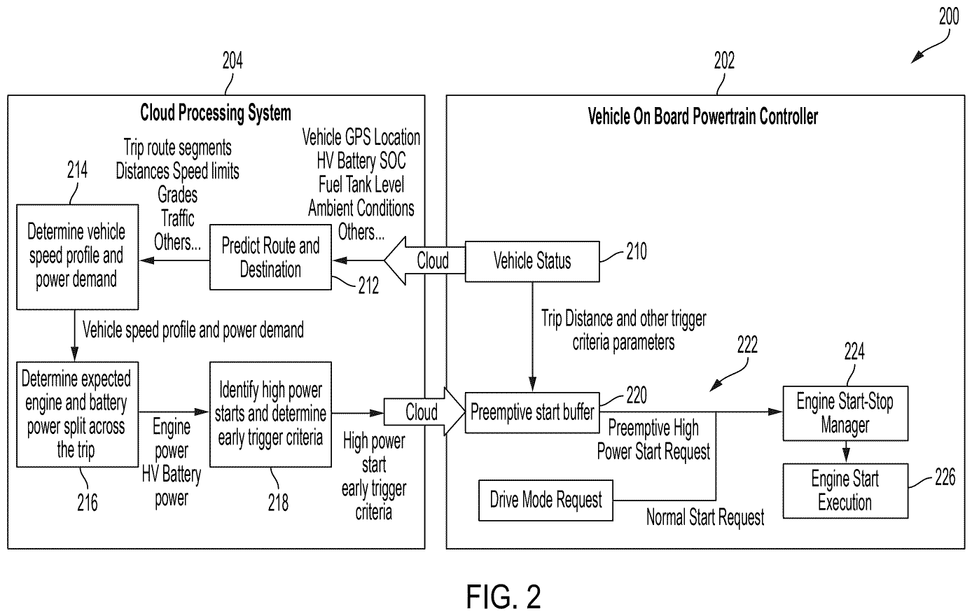

Referring now to FIG. 2, a flow diagram of an example operating method 200 of the preemptive high-power engine start system 104 for an electrified vehicle according to the principles of the present application is illustrated. While the method 200 specifically references the electrified vehicle 100 and its components for illustrative/descriptive purposes, it will be appreciated that the method 200 could be applicable to any suitably configured electrified vehicle.

In the example embodiment, the method 200 includes communication between a vehicle on-board powertrain controller 202 (e.g., control system 136) and a cloud processing system 204 (e.g., computing server 146). The method begins at 210 where controller 202 determines vehicle status data, such as vehicle GPS location, HV battery state of charge (SOC), a fuel tank level, ambient conditions, etc. The controller 202 then sends the vehicle status data to the cloud processing system 204. At 212, system 204 predicts a vehicle route and destination. This may be based on, for example, a user programmed route in the GPS navigation, historical driving data, AI prediction, etc. Based on the predicted route/destination, the system 204 determines specific information about the route such as, for example, trip route segments, distances, speed limits, road grades, traffic congestion, etc.

At 214, the system 204 determines a vehicle speed profile and power demand based on the predicted route/destination and associated information. In one example, the speed profile is the predicted vehicle speed for the trip, determined by the route, speed limits, traffic information, road grade, etc. The power demand is then the conversion of this speed profile to the vehicle power required to achieve it based on vehicle characteristics (e.g., weight, drag, rolling resistance, etc.). At 216, the system 204 determines an expected engine and battery power split across the predicted route. In one example, to achieve the vehicle speed and power profiles, many different combination of engine speed and torque, electric motor speed and torque, and gear selection can be used. An optimization algorithm can determine what these overall combinations are and then selects the best among them that minimizes fuel and battery energy usage.

At 218, the system 204 identifies/predicts one or more high-power start locations along the predicted route and determines early trigger criteria. In one example, from the engine power and HV battery power predictions for the trip, the control algorithm is configured to search for where engine starts are expected to occur along the trip (e.g., zero engine power to some positive amount of power) and the level of predicted engine power immediately following the start. If the level of predicted engine power following a start is above a calibratable threshold, then that start event would be identified as a ‘high power start.’ The trigger criteria are configured to command an engine start before the predicted high power start. The trigger criteria may be based on the progress through the route, battery SOC conditions, etc. For example, at mile five of a ten mile trip, start the engine if a high power start is expected at mile 5.5 or at 40% SOC start the engine if a high power start is expected at 35% SOC. The cloud processing system 204 then sends the high-power start early trigger criteria to the vehicle on-board powertrain controller 202.

At 220, the controller 202 determines a preemptive start buffer, which is a list of all the predicted triggers for a trip. In one example, the controller 202 is configured to sort the list to determine an order for which to use the triggers. At 222, based on the previous determinations, the controller 202 sends a preemptive high-power start request to other vehicle systems when the vehicle 100 is nearing a location where a high-power engine start is predicted to occur. In the example embodiment, the preemptive high-power start request is sent to an engine start/stop manager 224 (e.g., controller), which executes the engine start at 226 when the early trigger criteria are met.

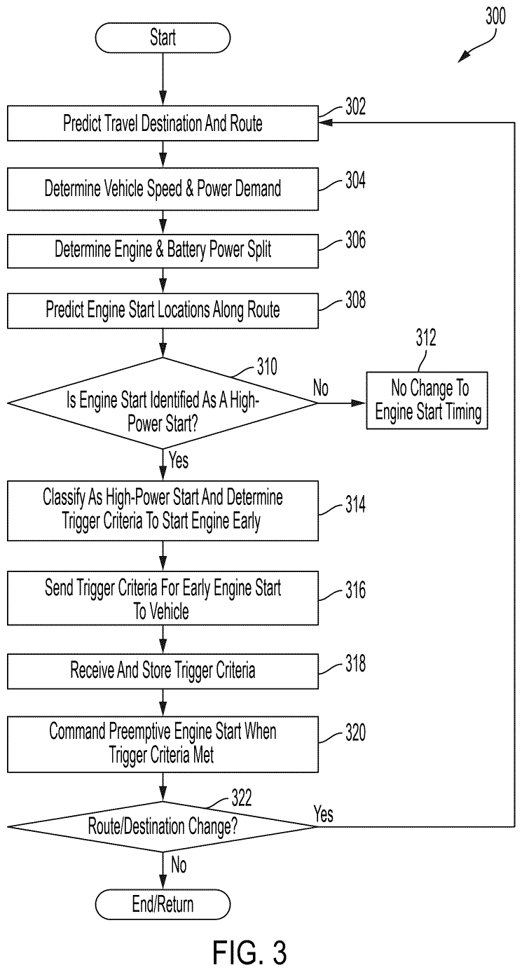

With reference now to FIG. 3, a flow diagram of an example operating method 300 of the preemptive high-power engine start system 104 for an electrified vehicle according to the principles of the present application is illustrated. While the method 300 specifically references the electrified vehicle 100 and its components for illustrative/descriptive purposes, it will be appreciated that the method 300 could be applicable to any suitably configured electrified vehicle.

In the example embodiment, the method begins at 302 where the control system 136 (“control”) predicts the destination/route of vehicle 100, for example, based on GPS navigation and/or historical driving data. At 304, control determines a vehicle speed and power demand profile for the destination/route. At 306, control determines an engine and battery power split across the destination/route. At 308, control predicts engine start locations along the route based on the engine power demand profile and/or power split (e.g., when engine positive power indicates an engine start).

At 310, control (which may also include computing server 146) determines if for each predicted engine start, is the engine start identified as a high-power start (e.g., when engine power exceeds a threshold). If no, control proceeds to 312 and there is no change to engine start timing. Control may then end or return to 302. If yes, control proceeds to 314 and classifies all applicable engine start events as a high-power start and determines trigger criteria to start the engine 128 earlier.

At 316, the trigger criteria are sent to all relevant vehicle systems, such as control system 136. For example, if the trigger criteria are processed/determined with the cloud-based computing server 146, the trigger criteria are sent to the control system 136. At 318, control receives and stores the trigger criteria. At 320, when the trigger criteria conditions are met during travel along the route, control commands a preemptive start of engine 128. At 322, control determines if there is a change detected in the route and/or destination. If yes, control returns to 302. If no, control ends or returns to 302.

It will be appreciated that the terms “controller” or “control system” or “module” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A preemptive high-power engine start control system for a hybrid electric vehicle (HEV) having an electrified powertrain including an electric motor and an internal combustion engine, the preemptive high-power engine start control system comprising:
a controller having one or more processors and a non-transitory computer-readable storage medium having a plurality of instructions stored thereon, which, when executed by the one or more processors, cause the one or more processors to perform operations comprising:
predict a vehicle travel route to a destination;
determine one or more locations along the travel route where a high-power engine start will occur that requires propulsive power from both the electric motor and the internal combustion engine to satisfy a driver torque demand; and
preemptively start the internal combustion engine prior to the vehicle reaching the one or more locations along the travel route where the high-power engine start will occur, to thereby facilitate preventing a torque delay during the high-power engine start.

2. The preemptive high-power engine start control system of claim 1, wherein the controller is further configured to:
determine a vehicle speed profile and power demand along the travel route; and
determine an expected engine and battery power split along the travel route.

3. The preemptive high-power engine start control system of claim 2, wherein the controller is further configured to:
determine the one or more locations along the travel route where the high-power engine start will occur, based on (i) the determined vehicle speed profile and power demand and (ii) the determined expected engine and battery power split.

4. The preemptive high-power engine start control system of claim 1, wherein the controller is further configured to:
determine trigger criteria to initiate the preemptive high-power engine start; and
preemptively start the internal combustion engine when the trigger criteria are met prior to the vehicle reaching the one or more locations along the travel route.

5. The preemptive high-power engine start control system of claim 4, wherein the trigger criteria comprise:
a progress through the travel route; and/or
a battery state of charge condition.

6. The preemptive high-power engine start control system of claim 1, wherein the controller is further configured to:
determine a vehicle status of the HEV;
send the vehicle status to a remote computing server; and
receive, from the remote computing server, the determined one or more locations along the travel route where a high-power engine start will occur.

7. The preemptive high-power engine start control system of claim 6, wherein the controller is further configured to:
receive, from the remote computing server, trigger criteria indicating when to initiate the preemptive high-power engine start; and
preemptively start the internal combustion engine when the trigger criteria are met prior to the vehicle reaching the one or more locations along the travel route.

8. The preemptive high-power engine start control system of claim 1, wherein the controller is further configured to:
determine a catalytic converter of the HEV is below a predetermined light-off temperature; and
preemptively start the internal combustion engine prior to the vehicle reaching the one or more locations along the travel route where the high-power engine start will occur, to thereby warm the catalytic converter to the predetermined light-off temperature to reduce exhaust emissions.

9. The preemptive high-power engine start control system of claim 1, wherein the controller is further configured to predict the travel route based on user input into a GPS navigation system of the HEV.

10. The preemptive high-power engine start control system of claim 1, wherein the controller is further configured to predict the travel route based on driving history data of the HEV.

11. A preemptive high-power engine start control method for a hybrid electric vehicle (HEV) having an electrified powertrain including an electric motor and an internal combustion engine, the method comprising:
predicting, by a controller having one or more processors, a vehicle travel route to a destination;
determining, by the controller, one or more locations along the travel route where a high-power engine start will occur that requires propulsive power from both the electric motor and the internal combustion engine to satisfy a driver torque demand; and
preemptively starting the internal combustion engine, by the controller, prior to the vehicle reaching the one or more locations along the travel route where the high-power engine start will occur, to thereby facilitate preventing a torque delay during the high-power engine start.

12. The method of claim 11, further comprising:
determining, by the controller, a vehicle speed profile and power demand along the travel route; and
determining, by the controller, an expected engine and battery power split along the travel route.

13. The method of claim 12, further comprising:
determining, by the controller, the one or more locations along the travel route where the high-power engine start will occur, based on (i) the determined vehicle speed profile and power demand and (ii) the determined expected engine and battery power split.

14. The method of claim 11, further comprising:
determining, by the controller, trigger criteria to initiate the preemptive high-power engine start; and
preemptively starting the internal combustion engine, by the controller, when the trigger criteria are met prior to the vehicle reaching the one or more locations along the travel route.

15. The method of claim 14, wherein the trigger criteria comprise:
a progress through the travel route; and/or a battery state of charge condition.

16. The method of claim 11, further comprising:
determining, by the controller, a vehicle status of the HEV;
sending, by the controller, the vehicle status to a remote computing server; and
receiving, from the remote computing server and by the controller, the determined one or more locations along the travel route where a high-power engine start will occur.

17. The method of claim 16, further comprising:
receiving, from the remote computing server, trigger criteria indicating when to initiate the preemptive high-power engine start; and
preemptively starting the internal combustion engine, by the controller, when the trigger criteria are met prior to the vehicle reaching the one or more locations along the travel route.

18. The method of claim 16, further comprising:
determining, by the controller, if a catalytic converter of the HEV is below a predetermined light-off temperature; and
preemptively starting the internal combustion engine, by the controller, prior to the vehicle reaching the one or more locations along the travel route where the high-power engine start will occur, to thereby warm the catalytic converter to the predetermined light-off temperature to reduce exhaust emissions.

19. The method of claim 11, wherein the predicted travel route is based on user input into a GPS navigation system of the HEV.

20. The method of claim 11, wherein the predicted travel route is based on driving history data of the HEV.
